(19) United States
(12) Patent Application Publication
(10) Pub. No.: US 2010/0281514 A1
(43) Pub. Date: Nov. 4, 2010

(54) SYSTEM FOR MANAGING IDENTITY WITH PRIVACY POLICY USING NUMBER AND METHOD THEREOF

(75) Inventors: Jonghyouk Noh, Daejeon (KR); Seunghyun Kim, Daejeon (KR); Soohyung Kim, Daejeon (KR); Daeseon Choi, Daejeon (KR); Sangrae Cho, Daejeon (KR); Youngseob Cho, Daejeon (KR); Seunghun Jin, Daejeon (KR); Kyoil Chung, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/746,498

(22) PCT Filed: Dec. 3, 2008
(86) PCT No.: PCT/KR2008/007130

§ 371 Date: Jun. 4, 2010

(30) Foreign Application Priority Data
Dec. 5, 2007 (KR) 10-2007-0125439
Nov. 4, 2008 (KR) 10-2008-0108911

(51) Int. Cl. H04L 9/32; G06Q 50/00; G06F 17/30

(52) U.S. Cl. 726/1; 726/28

(57) ABSTRACT

The present invention includes a request module that creates a user information request message and a communication module that transmits the user information request message to an attribute provider server, wherein the user information request message includes a privacy policy that represents at least one term of use subjects, use purposes, and use periods using a grade. With the present invention, the representation of the privacy policy can be simplified and the comparison of policies can be conveniently processed.

### TECHNICAL FIELD

The present invention relates to a system for managing identity with a privacy policy for each grade and a method thereof, and more specifically, to a system for managing identity that represent a privacy policy using a number and a method thereof.

This work was supported by the IT R&D program of MIC/IITA. [2007-S-601-01, User Control Enhanced Digital Identity Wallet System].

### BACKGROUND ART

Many sites on the Internet request personal information for registering a user while providing Internet services to the user. Accordingly, the user must provide his/her important personal information, such as name, resident registration number, address, telephone number, e-mail address, etc., when he/she joins the sites in order to use the Internet services. However, since the user joins numerous sites, it is not easy for him/her to memorize each of the sites his/her personal information is provided to and what information is provided. Also, a large number of small sites do not care about their protection of information and privacy in terms of managing information about their customers as well as even illegally sells personal information regarding their customers.

In this situation, there have been proposed technologies to safely manage and share the user's personal information. As the representative technology, there is a system for managing Internet identity. The system for managing Internet identity is to create a convenient and safe environment when the user provides personal information while using the Internet. In other words, the system for managing Internet identity provides a Single Sign On (SSO) service that can freely use a large number of sites on the Internet through a one time log-in procedure and optimally maintains and safely manages the user's personal information by storing his/her personal information in a safe site. To this end, many standards and technologies are being developed. As the representative standard and technology, there are: SAML available from the OASIS Group; ID-FF, ID-WSF, and ID-SIS available from Liberty Alliance; and WS-Security available from IBM and Microsoft (MS). As another standard for safely managing the user's personal information, there are: P3P available from W3C; XACML available from OASIS; EPAL available from IBM, and the like.

The P3P is used to control cookies in the Internet Explorer that is now a web browser of MS. The XACML, which is a standard for representing an access control policy, defines a policy representation language, an access control request message, a response message, etc. The EPAL, which is a method of controlling a company to share the user information, defines a policy representation language similar to the XMCML.

Meanwhile, the system for managing Internet identity manages the user's personal information in an attribute provider (AP) server, which is a site or system trusted by the user. When the user uses the Internet services at a different site, that is, an Attribute Consumer (AC) server, if the attribute consumer server needs the user's personal information, the attribute consumer server asks the attribute provider server for the user's personal information. In response to the request, the attribute provider server provides or does not provide the user's personal information to the attribute consumer server by determining whether or not it provides the user's personal information according to a user's rule. In some cases, the attribute provider server obtains the user's consent to provide his/her personal information to the attribute consumer server. As described above, in the system for managing Internet identity, the attribute provider server, which is a reliable site or system, manages the user's personal information, such that the user can safely manage his/her personal information. Also, the attribute consumer server, which provides the Internet service, asks the attribute provider server for the user's personal information only when needed, such that the user's personal information is not unnecessarily spread and distributed into various locations.

As described above, in the system environment for managing Internet identity or an environment for managing the user's personal information using the method similar to the method used in the system environment, the distribution of the user's personal information should be performed according to only the user' rule, the privacy policy, or an agreement between the user and the attribute provider server. To this end, a need exists for a system that enables the user to determine whether his/her personal information is distributed counter to the desired method or rules.

Controlling the distribution of personal information generally depends on the following process.

First, the attribute consumer server, which wants to use the personal information, transmits a message to be “provide information on a specific user's resource in order to perform action on the specific user's resource for a specific purpose” to the attribute provider server that stores the user's personal information. When the attribute provider server receives the personal information request message transmitted from the attribute consumer server, it determines whether to distribute the information according to the privacy policy stored therein. When the determination is permission, the attribute provider server creates a message to be “permit the information distribution but necessarily keep a specific obligation” and provides it to the attribute consumer server. When the determination is rejection, a message to be “non-permit the information distribution”is created and transmitted to the attribute consumer server. As a result, the attribute consumer server is operated depending on the received message.

In the above-mentioned process, the privacy policy, which is based on the determination on the distribution of the user's personal information, can be represented in various methods. For example, there are the XACML and the EPAL, and the like. Components of the privacy policy may generally include subjects using information, resources to be used, and actions on information. In addition, there are conditions, purposes, and obligations to be observed when using information.

The region in which the systems requesting the information, providing the information, and determining the information distribution are operated according to the privacy policy, as described above, is called a privacy domain. The privacy policy may include subjects, user information lists, actions to be performed and the like which belong to the privacy domain.

On the other hand, in the case of the privacy policy (for example, XACML, EPAL) of the related art, since it is represented by a detail and complex method, when the user's personal information is distributed, it is not easy for the user to determine whether or not to permit the distribution of his/her personal information. Therefore, the user may determine an incorrect determination on whether or not to permit the distribution of his/her personal information, such that the case where the user undesirably provides his/her personal information to the attribute consumer server often occurs.

### DISCLOSURE OF INVENTION

### Technical Problem

The present invention proposes to solve the above-mentioned problems.

It is an object of the present invention to provide a method of simply representing a privacy policy of user's personal information distributed on the Internet, and a method and apparatus of simply processing a determination of whether or not to permit the distribution of the user's personal information when it is distributed.

### Technical Solution

An attribute consumer server used in a system for managing identity according to the present invention includes: a request module that creates a user information request message; and a communication module that transmits the user information request message to a server for an attribute provider server, wherein the user information request message includes a privacy policy that represents at least one term of use subjects, use purposes, and use periods using a grade.

In particular, the privacy policy further includes at least one term of use conditions and obligations in the use, which are based on a grade.

Further, the grade is represented by a number.

Meanwhile, an attribute provider server in a system for managing identity according to the present invention includes: a communication module that receives from an attribute consumer server a user information request message including a privacy policy that represents at least one term of use subjects, use purposes, and use periods using a grade; a privacy policy DB that stores the user's privacy policy that represents at least one term of use subjects, use purposes, and use periods using the grade; and a determination module that analyzes the user information request message to extract the user's privacy policy from the privacy policy DB and compares the extracted privacy policy and the privacy policy included in the user information request message to determine whether or not to provide the user information.

In particular, the determination module compares the grades for each term of the privacy policy included in the user information request message and the extracted privacy policy and provides the user information to the attribute consumer server only when the privacy policy included in the user information request message has the grade equal to or higher than the extracted privacy policy.

Further, the privacy policy further includes at least one term of the use conditions and the obligations in the use, which are represented using the grade.

Further, the grade is represented by a number.

Meanwhile, a method for managing identity according to the present invention, which is a method for allowing an attribute provider server in the system for managing identity to manage user information, includes: receiving a user information request message including a privacy policy that represents at least one term of a privacy policy representing use subjects, use purposes, and use periods using a grade; analyzing the user information request message to extract the privacy policy of the corresponding user from a privacy policy DB; and comparing the extracted privacy policy and the privacy policy included in the user information request message to determine whether or not to provide the user information, wherein the privacy policy DB stores the privacy policy of the user representing at least one term of use subjects, use purposes, and use periods using the grade.

In particular, the privacy policy further includes at least one term of the use conditions and the obligations in the use, which are represented using the grade.

Further, the grade is represented by a number.

### ADVANTAGEOUS EFFECTS

The present invention has the following effects.

The privacy policy representation can be simplified and the policy comparison can be conveniently processed. Since the privacy policy is conveniently represented, when the user's personal information is distributed, it is easy for the user to determine whether or not to permit the distribution of the user's personal information. Therefore, the user can accurately determine whether the distribution of the user's personal information is permitted, prevent his/her personal information from being distributed to an undesired attribute consumer server, and conveniently and safely manage his/her personal information.

### BRIEF DESCRIPTION OF THE DRAWINGS

FIG. 1 is a view for schematically explaining a system for managing identity having a privacy policy for each grade according to the present invention;

FIG. 2 is a detailed view for explaining in detail a system for managing identity having a privacy policy for each grade according to the present invention;

FIG. 3 is an exemplification view for explaining a privacy policy according to the present invention; and

FIG. 4 is a flow chart for explaining a method for allowing an attribute provider server to manage user's identity according to the present invention.

### BEST MODE FOR CARRYING OUT THE INVENTION

Hereinafter, exemplary embodiments of the present invention will be described with reference to the accompanying drawings. Herein, the detailed description of known functions and configurations will be omitted so as not to obscure the subject of the invention with unnecessary detail. The exemplary embodiment of the present invention is provided to those skilled in the art to more completely explain the present invention. Therefore, shape and size, etc. of components in the drawings can be exaggerated to more clearly explain the present invention.

### MODE FOR THE INVENTION

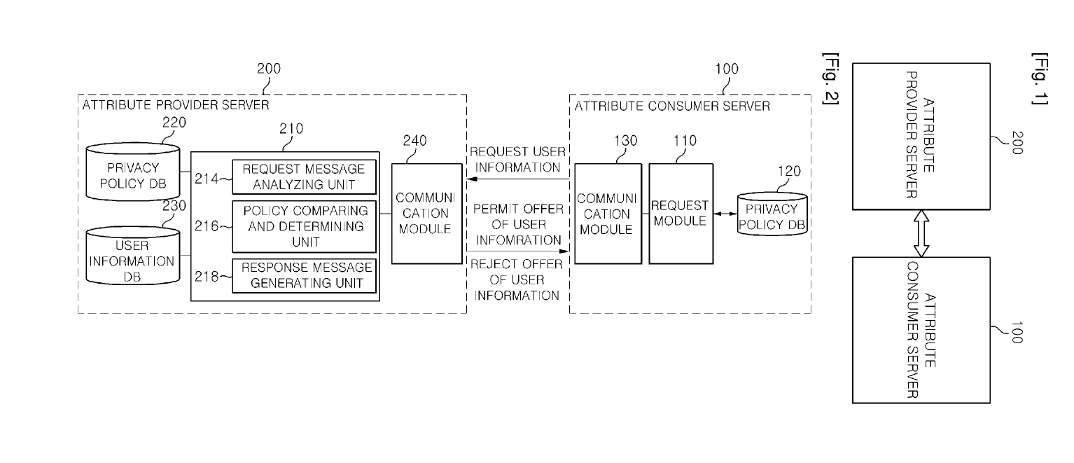

FIG. 1 is a view for schematically explaining a system for managing identity having a privacy policy for each grade according to the present invention. FIG. 2 is a view showing one embodiment of a privacy policy stored in privacy policy databases 120 and 220 of FIG. 1.

The system for managing identity according to the present invention includes an attribute consumer server 100 and an attribute provider server 200.

The attribute consumer server 100 is a service provider server that provides predetermined Internet services to a user using Internet connection tools, such as mobile terminals, desk tops, or notebooks. For example, it may be an Internet service provider that provides shopping service, financial service, game service, and the like. When the user uses the Internet services provided by the attribute consumer server 100, if the attribute consumer server 100 needs the user information, the attribute consumer server 100 creates the request message including its privacy policy and requests user information to the attribute provider server 200. Further, the attribute provider server 200 receives the request message from the attribute consumer server 100 and compares the privacy policies owned by the attribute provider server to determine whether or not to provide the corresponding user information to the attribute consumer server 100. Also, the attribute provider server 200 can permit or not permit of the offer of the user information to the attribute consumer server 100 according to the determination result.

FIG. 2 is a detailed view for explaining in detail a system for managing identity having a privacy policy for each grade according to the present invention;

The attribute consumer server 100 includes a request module 110, a privacy policy database 120 (hereinafter, referred to as ‘privacy policy DB’), and a communication module 130.

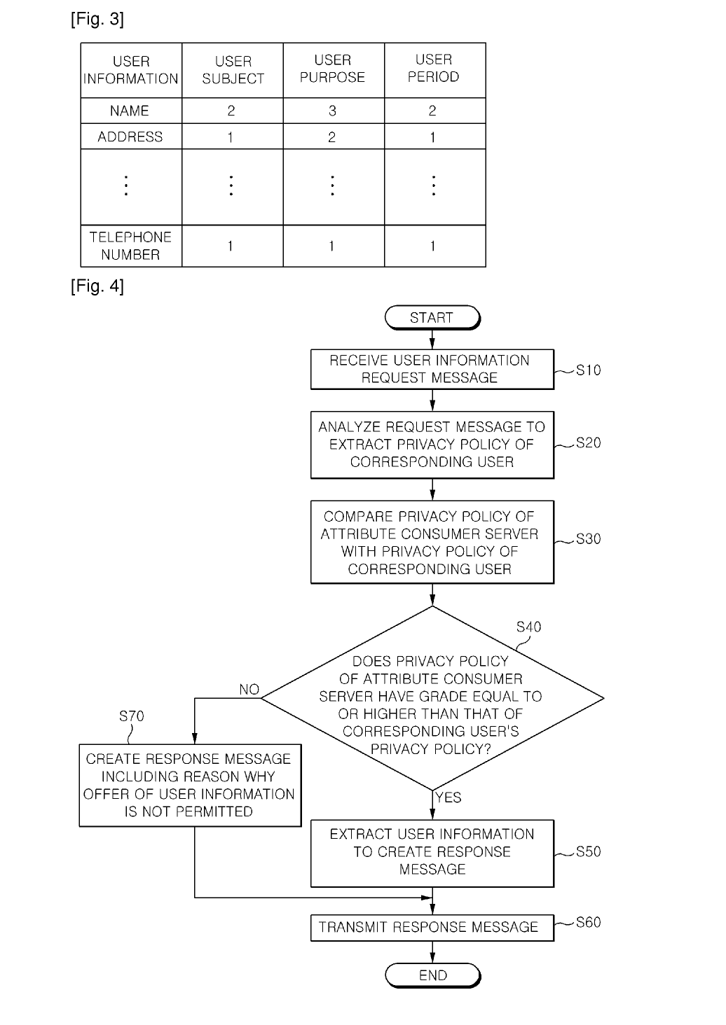

The privacy policy DB 120 stores a privacy policy of the attribute consumer server 100. The privacy policy according to the embodiment of the present invention, which is stored in the privacy policy DB 120, can be represented as shown in FIG. 3. More specifically, the privacy policy of the present invention represents one data term (for example, user information), that is, a term, such as the use subjects, the use purposes, the use periods, etc., using a grade (for example, a number).

The “use subject’ is an object that uses the corresponding data. For example, the ‘use subject’ may be an individual that obtains the current user information, an individual that is lawfully guaranteed, an individual that is lawfully associated with the individual obtaining the user information, a third party that has nothing to do with the individual obtaining the user information, etc. The division for the above-mentioned use subjects is merely one embodiment and the use subjects can be subdivided for each privacy domain and variously represented. In the present invention, the use subjects represented as described above are divided using a grade. For example, the use subject for one user information can be divided and represented as follows: when the use subject is limited to only the individual that obtains the current user information, it is set to a first grade; when the use subject is limited to the individual that is lawfully guaranteed, it is set to a second grade; when the use subject is limited to the individual that is lawfully associated with the individual obtaining the user information, it is set to a third grade; and when the use subject is limited to the third part that has lawfully nothing to do with the individual obtaining the user information, it is set to a fourth grade.

The ‘use purpose’ means that the attribute consumer server 100 uses the user information. For example, the use purpose may be user services, statistics, marketing, a third purpose, etc. The division for the above-mentioned use purposes is merely one embodiment and the use subjects can be subdivided for each privacy domain and variously represented. In the present invention, the use purposes represented as described above are divided using a grade. For example, the use subject for one user information can be divided and represented as follows: when the use purpose is limited to providing services to the user, it is set to a first grade; when the use purpose is limited to statistics, it is set to a second grade; when the use purpose is limited to marketing, it is set to a third grade; and when the use purpose is limited to a third purpose, it is set to a fourth grade.

Also, the ‘use period’ means a period where the attribute consumer server 100 uses the user information. In other words, the use period means a period where the attribute consumer server 100 obtains the user information and then stores the information. For example, it may be within one day, within three days, within five days, five days or more, etc. The division for the above-mentioned use period is merely one embodiment and the use periods can be subdivided for each privacy domain and variously represented. In the present invention, the use periods represented as described above are divided using a grade. For example, when the period where the attribute consumer server 100 obtains one user information and then stores it is within one day, it is set to a first grade; when the period where the attribute consumer server 100 obtains one user information and then stores it is within three days, it is set to a second grade; when the period where the attribute consumer server 100 obtains one user information and then stores it is within five days, it is set to a third grade; and when the period where the attribute consumer server 100 obtains one user information and then stores it is five days or more, it is set to a first grade.

As can be appreciated from the above examples, the smaller the number, the stricter the privacy policy is. However, the grades of the use subjects, the use purposes, and the use periods, and the like, which are represented in the privacy policy, are not represented by only a number and can be simply represented by a grade representing method promised between the attribute consumer server and the attribute provider server. For example, it is possible to represent a degree of the grade by correspondingly assigning alphabet letter, that is, A-B-C-D.

Also, as described above, the privacy policy according to the present invention can be more variously represented according to the privacy domain. And, in addition to the use subject, the use purpose, and the use period, the use condition and the obligation in the use, and the like may be included according to the privacy domain.

The request module 110 extracts the privacy policy of the corresponding user from the privacy policy DB 120 when the attribute consumer server 100 needs the user information. And, the request module 100 creates the user information request message (hereinafter, referred to ‘request message’) including the identification information of the corresponding user and the privacy policy of the corresponding user.

A communication module 130 transmits the request message created in the request module 110 to the attribute provider server 200.

The attribute provider server 200 includes a determination module 210, a privacy policy database 220 (hereinafter, ‘privacy policy DB’), a user information database 230 (hereinafter, ‘user information DB’), and a communication module 240.

First, the privacy policy DB 220 stores the privacy policy of the attribute provider server 200. Herein, the privacy policy stored in the privacy policy DB 220 may be uniquely established for each user. For example, an A user and a B user stored in the privacy policy DB 220 may use different privacy policies and share the same privacy policies.

The privacy policy is represented as shown in FIG. 3, and may be differently represented for each user and stored in the privacy policy DB 220.

The user information DB 230 stores the user's personal information. The user's personal information, which means the information indicating features owned by a person, indicates a company address, a home address, a telephone number, user information such as a family issued or registered from or in an organization such as a government or a company, a school career, taste, a religion, and the like. In other words, the user's personal information means the personal information that can uniquely identify a person. The user's identity stored in the user information DB 230 may be personal information directly prepared by the user, personal information issued from the reliable organization, and false information, and the like.

When the determination module 210 receives the message that requests the user's personal information from the attribute consumer server 100, it analyzes the received request message to determine which user information is requested by the attribute consumer server 100 using the user identification information included in the request message and extract the privacy policy of the corresponding user from the privacy policy DB 220. Further, the determination module 210 compares the extracted privacy policy and the privacy policy (that is, the privacy policy received from the attribute consumer server) included in the request message to determine whether or not to provide the user information to the attribute consumer server 100. Also, the determination module 210 creates a response message corresponding to the determination result.

More specifically, the determination module 210 includes a request message analyzing unit 214, a policy comparing and determining unit 216, and a response message creating unit 218.

The request message analyzing unit 214 analyzes the request message received from the attribute consumer server 100 through the communication module 240 to determine which user information is requested by the attribute consumer server 100 using the user identification information included in the request message and extracts the privacy policy of the corresponding user from the privacy policy DB 220.

The policy comparing and determining unit 216 receives the extracted privacy policy from the request message analyzing unit 214 and compares the extracted privacy policy with the privacy policy included in the request message to determine whether or not to provide the user information to the attribute consumer server 100.

The response message generating unit 218 creates the response message corresponding to the determination result in the policy comparing and determining unit 216. In other words, when the offer of the user information is permitted according to the determination result in the policy comparing and determining unit 216, the response message generating unit 218 obtains the corresponding user information from the user information DB 230 and creates the response message. To the contrary, when the offer of the user information is not permitted according to the determination result in the policy comparing and determining unit 216, the response message generating unit 218 creates the response message including the non-permitted reason.

The communication module 240 receives the request message transmitted from the attribute consumer server 100 and transmits the request message to the determination module 210 and transmits the response message transmitted from the determination module 210 to the attribute consumer server 100.

FIG. 4 is a flow chart for explaining a method for allowing the attribute provider server to manage the user's identity according to the present invention.

First, the attribute provider server 200 receives the message (hereinafter, referred to ‘request message’) requesting the user information from the attribute consumer server 100 (S10). The request message received by the attribute provider server 200 from the attribute consumer server 100 includes the privacy policy that is represented using a grade. In other words, the request message includes the privacy policy of the attribute consumer server 100 that represents the use purpose, the use subject, and the use period of the user information, and the like using a grade. Further, the request message includes identification information that can identify the corresponding user, such that the attribute provider server 200 receiving the request message can identify the user. Meanwhile, as described above, the ‘use subject’ is herein an object that uses the corresponding data item. For example, it may be an individual that obtains the current user information, an individual that is lawfully guaranteed, an individual that is lawfully associated with the individual obtaining the user information, a third party that has nothing to do with the individual obtaining the user information, etc. And, the ‘use purpose’ means a purpose using the user information. For example, it may be user services, statistics, marketing, a third purpose, etc. The ‘use period’ means a period using the user information. In other words, it means a period where the attribute consumer server obtains the user information and then stores the user information. For example, it may be within one day, within three days, within five days, five days or more, etc.

When the attribute provider server 200 receives the request message from the information consumer server 100, it analyzes the received request message to determine which user information is requested by the attribute consumer server 100 using the identification information included in the request message and extracts the privacy policy of the corresponding user from the privacy policy DB (S20).

Next, the attribute provider server 200 compares the extracted privacy policy and the privacy policy included in the request message to determine whether or not to provide the user information to the attribute consumer server 100 (S30). Herein, the attribute provider server 200 determines whether the privacy policy of the attribute consumer server is equal to or stricter than the privacy policy of the corresponding user (S40).

According to the determination result at step S40, when the privacy policy of the attribute consumer server 100 is equal to or stricter than the privacy policy of the corresponding user, the attribute provider service 200 extracts the user information of the corresponding user from the user information DB and creates the response message including the extracted user information (S50). For example, in the case of the privacy policy that represents the terms, such as the use subject, the use purpose, and the use period, using the number, when the privacy policy of the attribute consumer server 100 has a number that is equal to or lower than the privacy policy of the attribute provider server 200, the attribute provider server 200 provides the user information to the attribute consumer server 100. At this time, the lower the number, the stricter the grade becomes, that is, the stricter the privacy policy becomes.

To the contrary, according to the determination result at step S40, when the privacy policy of the attribute consumer server is not equal to or stricter than the privacy policy of the corresponding user, the attribute provider service 200 creates the response message including the reason why the offer of the user information is not permitted (S70). For example, the response message including a message to be “the user information cannot be provided due to the privacy policy” is created.

Next, the attribute provider server 200 transmits the response message created at step S50 or S70 to the attribute consumer server 100 (S60).

As described above, the exemplary embodiments are disclosed in the drawings and specification. Specific terms are herein used, but are merely used for the purpose of describing the present invention and are not used for limiting the meanings or the scope of the present invention described in claims. Therefore, it will be apparent to those skilled in the art that various changes and other embodiments can be made without departing from the spirit and scope of the present invention. Accordingly, the technical scope of the present invention will be defined in the following claims.

1. An attribute consumer server in a system for managing identity including:
a request module that creates a user information request message; and
a communication module that transmits the user information request message to an attribute provider server,
wherein the user information request message includes a privacy policy that represents at least one term of use subjects, use purposes, and use periods using a grade.

2. The attribute consumer server according to claim 1, wherein the privacy policy further includes at least one term of use conditions and obligations in the use, which are represented using a grade.

3. The attribute consumer server according to claim 1, wherein the grade is represented by a number.

4. An attribute provider server in a system for managing identity including:
a communication module that receives from an attribute consumer server a user information request message including a privacy policy that represents at least one term of use subjects, use purposes, and use periods using a grade;
a privacy policy DB that stores the user's privacy policy that represents at least one term of use subjects, use purposes, and use periods using the grade; and
a determination module that analyzes the user information request message to extract the user's privacy policy from the privacy policy DB and compares the extracted privacy policy and the privacy policy included in the user information request message to determine whether or not to provide the user information.

5. The attribute provider server according to claim 4, wherein the determination module compares the grades for each term of the privacy policy included in the user information request message and the extracted privacy policy and provides the user information to the attribute consumer server only when the privacy policy included in the user information request message has the grade equal to or higher than the extracted privacy policy.

6. The attribute provider server according to claim 4, wherein the privacy policy further includes at least one term of the use conditions and the obligations in the use, which are represented using the grade.

7. The attribute provider server according to claim 5, wherein the grade is represented by a number.

8. A method for allowing an attribute provider server in a system for managing identity to manage user information including:
receiving a user information request message including a privacy policy that represents at least one term of use subjects, use purposes, and use periods using a grade;
analyzing the user information request message to extract the privacy policy of the corresponding user from a privacy policy DB; and
comparing the extracted privacy policy and the privacy policy included in the user information request message to determine whether or not to provide the user information,
wherein the privacy policy DB stores the user's privacy policy that represents at least one term of use subjects, use purposes, and use periods using the grade.

9. The method according to claim 8, wherein the privacy policy further includes at least one term of the use conditions and the obligations in the use, which are represented using the grade.

10. The method according to claim 8, wherein the grade is represented by a number.
